(19) United States
(12) Patent Application Publication
(10) Pub. No.: US 2018/0242427 A1
(43) Pub. Date: Aug. 23, 2018

(54) SENSOR ARRANGEMENTS

(71) Applicant: Gooee Limited, St Albans (GB)

(72) Inventors: Andrew Johnson, Klosters (CH); Jame Xie, Gan Zhou City (CN)

(73) Assignee: Gooee Limited, St Albans (GB)

(21) Appl. No.: 15/890,706

(22) Filed: Feb. 7, 2018

(30) Foreign Application Priority Data
Feb. 17, 2017 (GB) GB1702595.8

(51) Int. Cl. H05B 37/02; H05B 33/08; G02B 27/09

(52) U.S. Cl. CPC H05B 37/0227; H05B 33/0857; G02B 27/0955; H05B 37/0218; H05B 33/0845

(57) ABSTRACT

A luminaire component for use in a luminaire is described. The component may include a printed circuit board (PCB) having a front face, and an LED module on the front face. The component may further include a sensor arrangement comprising one or more sensors, and an optical system/lens for focusing light emitted by the LED module. The optical lens may include an outwardly extending flange. The sensor arrangement may be located between the LED module and the outwardly extending flange such that at least one of the sensors is a forward facing sensor that\views the environment through the flange. Luminaires, such as downlight luminaires, including a luminaire component is described.

### CROSS-REFERENCE TO RELATED APPLICATIONS

This application claims the benefit of GB Patent Application GB1702595.8, filed Feb. 17, 2017, which is incorporated herein by reference in its entirety.

### FIELD OF THE DISCLOSURE

The present disclosure is related to smart luminaires. It is particularly applicable, but in no way limited, to luminaire components designed to incorporate a sensor arrangement into a downlight, including incorporating a sensor arrangement into or associated with a lens in a downlight.

### BACKGROUND OF THE DISCLOSURE

Luminaires or light fixtures, which include or are connected to a motion sensor are known, and these are particularly useful for causing a lamp in the luminaire to illuminate when a person is present. This is a convenient way of saving energy when an area is unoccupied, for eliminating light switches inside buildings, and for lighting pathways etc outside at night.

A similar approach has also been developed for thermostats, which include or are connected to a motion sensor or light sensor. These collect data on the day length, habitation status and energy usage. However there is generally only one thermostat in a house, or in one particular industrial or commercial area, so coverage by any sensor associated with a thermostat is very limited.

Intruder alarm systems, which utilise sensors of various types are also known. The sensors include PIR detectors, pressure switches, and switches that detect opening of doors and windows. Each of these sensors has a specific function and they are usually connected to an alarm controller.

LED Downlight fittings or downlighters are a form of lighting unit becoming more and more widely used as light sources in domestic and commercial environments. They offer significant energy savings when compared with traditional incandescent lighting, whilst being particularly neat and unobtrusive in their appearance, since almost the entire downlight fitting is concealed behind a ceiling or other suitable panel or surface, whilst giving out a pleasing light. They also have the advantage that they may be used in considerable numbers to light an area, and therefore potentially offer significantly more comprehensive area coverage than a thermostat or a stand alone intruder alarm sensor.

Luminaires including downlights that incorporate sensors are described in GB Patent Application No. GB2526440A, the entire text of which is hereby incorporated by reference, and is intended to form an integral part of this disclosure to the extent that it is consistent with this disclosure. The arrangements shown and described in GB Patent Application No. GB2526440A are complex, and may be difficult to incorporate into downlights and relatively expensive to manufacture. It must be appreciated that the market for downlights is very competitive and price sensitive.

The embodiments described in the present disclosure overcome or mitigate some or all of the disadvantages outlined above.

### SUMMARY OF THE EXEMPLARY EMBODIMENTS

This disclosure relates to ‘smart’ luminaire components and complete ‘smart’ luminaires that contain detectors that sense information about their local environment and which communicate this information to a processor. These luminaires offer a way of collecting data about the environment in which they are situated. This overcomes the problems associated with a dedicated sensor in a particular location, such as a thermostat which only covers a limited area, because a building or house will contain many luminaires of different types, each capable of gathering data. The data gathered by the luminaires described herein may include a much higher granularity than data collected by other approaches, and is therefore more useful. The use of communication protocols such as ZigBee, Wi-Fi, 6LoWPAN Bluetooth® or Bluetooth LE between the sensor arrangement and/or the luminaire and a remote gateway leads to improved designs, which are simpler and less expensive to manufacture.

According to an aspect, a luminaire component for use in a luminaire is provided. In this context, the term ‘luminaire component’ has a broad meaning and refers to any component, or combination of components, suitable for incorporation into any form of luminaire. The luminaire component may include an LED module including an LED light source on a first printed circuit board (PCB). The first PCB may include a front face on which the LED module is located. According to an aspect, the luminaire component includes an optical system/lens for focusing light emitted by the LED module. The lens may incorporate an outwardly extending flange. The luminaire component may further include a sensor arrangement that incorporates one or more sensors. The sensor arrangement may be located between the LED module and the outwardly extending flange of the lens such that at least one sensor is forward facing and views the environment through the flange of the lens. By physically separating the sensor arrangement from both the lens and from the LED module this simplifies construction, reduces cost, and allows maximum flexibility. Accordingly, a luminaire can be constructed without any sensors, or with one or more of a variety of sensors, depending on a customer's requirements simply by varying just the sensor arrangement component. All other components can remain the same.

There are a number of optical systems that can be used to focus light from an LED and typically current LED luminaires use lenses.

According to an aspect, the luminaire component further includes a connection mechanism/means adapted to connect the sensor arrangement to the LED module PCB. This connection mechanism provides power to the sensor arrangement and conveys data gathered by the sensor arrangement. It can also provide two-way data transfer if required. The connection mechanism can take a wide variety of forms, as determined by the appropriate design expert. For example the connection mechanism could comprise a plurality of male and female pin connectors, or one or more electrical contact points.

In an embodiment, the sensor(s) that view the environment through the flange of the lens view the environment through an aperture in the flange. In this context the term ‘aperture’ has a broad meaning. The flanges around these lenses are generally opaque or frosted. An aperture can take the form of a substantially transparent window or gap in the frosted flange, a physical hole in the flange, or a small substantially transparent optical lens such as a convex lens built into the flange in order to spread the sensor detection angle. In an embodiment, the transparent element in the flange includes a convex lens in front of the sensor arrangement in order to spread the sensor detection angle.

According to an aspect, the sensor arrangement includes at least one rearward facing sensor adapted to view light emitted by the LED module. Although the rearward facing sensor may be outside the main body of the lens, sufficient light may escape in order to monitor characteristics of the light emitted by the LED module.

The sensor arrangement may be mounted on a second PCB. By providing a second PCB mounted in front of and, in an embodiment, away from the first LED carrying PCB, it is possible for the first time to introduce new functionality into a luminaire, such as by incorporating one or more data communication devices onto the second PCB. According to an aspect, this second PCB is substantially annular and thus follows the profile of the annular flange around the outside of the lens.

It will be understood that embodiments of the present disclosure also extends to include luminaires, including downlight luminaires, incorporating a luminaire component according to the present disclosure.

In an embodiment, the lens is substantially frustoconical in cross-section with an outwardly extending flange around the perimeter of the front of the lens.

The sensor arrangement may include a first sensor array directed substantially away from the luminaire for detecting information about the environment below the luminaire. The sensor arrangement may further include a second sensor array directed substantially toward the LED light source in the luminaire for detecting information about the operation of the light source.

In an embodiment, the second sensor array detects a luminous flux of light emitted by the luminaire and alternatively or additionally the second sensor array detects the colour temperature of light emitted by the LED light source.

In an embodiment, the first and the second sensor arrays are both mounted on the second PCB.

Embodiments of the present disclosure also extend to include a luminaire incorporating a luminaire component as described herein. The luminaire may include a downlight or a lamp.

According to an aspect, the sensor includes one or more from the group of sensors comprising: proximity sensors, including capacitive, capacitive-displacement, conductive, magnetic, optical, thermal, and sonar sensors; motion sensors, including passive infrared (“PIR”) motion detectors, ultrasonic, microwave, and tomographic motion detectors; acoustic sensors including microphones; charge-coupled detectors; low-resolution digital cameras; thermopiles; thermocouples; carbon dioxide sensors; water-vapour detectors; flow meters; and pressure sensors, field-strength sensors for magnetic and electrical fields.

According to an aspect, the environmental characteristic measured by the sensor include; changes in temperatures, gasses exhaled by human beings and other living creatures; types of sounds or sound patterns; changes in ambient light due to moving objects; changes in pressure within an environment due to opening and closing of doors, windows, or motion of large objects through the air; and other such pressure changes; rate of flow of water, natural gas, and other gasses; and temporal changes in field strength.

In an embodiment, the LED module includes one or more LEDs.

Accordingly, embodiments of the present disclosure are directed toward a luminaire component which includes a sensor or sensors, an LED light source, a lens, and optionally a processor or processors for processing data from the sensor

The data collected by the sensor/(s) may be collected and stored. According to an aspect, the data is processed to perform one or more functions, including to control how a luminaire or a lamp in a lighting fixture operates, to monitor the status of the luminaire/lamp, and to control other remote equipment.

Embodiments of the present disclosure allows a smart-home environment to include a number of intelligent, multi-sensing, network-connected devices. These smart-home devices are able to intercommunicate and are integrated together within the smart-home environment. The smart-home devices may also communicate with cloud-based smart-home control and/or data-processing systems in order to distribute control functionality, to access higher capacity and more reliable computational facilities, and to integrate a particular smart home into a larger, multi-home or geographical smart-home-device-based aggregation.

In general, smart-home devices may include one or more different types of sensors, one or more controllers and/or actuators, and one or more communications interfaces that connect the smart-home devices to other smart-home devices, routers, bridges, hubs and gateways within a local smart-home environment, various different types of local computer systems, and to the Internet, through which a smart-home device may communicate with cloud-computing servers and other remote computing systems. Data communications are generally carried out using any one or combination of a large variety of different types of communications media and protocols, including wireless protocols, such as Wi-Fi, ZigBee, 6LoWPAN, Bluetooth, BLE and various types of wired protocols, including CAT6 Ethernet, HomePlug and other power line communication (PLC) protocols, and various other types of communications protocols and technologies. Smart-home devices may themselves operate as intermediate communications devices, such as repeaters, for other smart-home devices. The smart-home environment may additionally include a variety of different types of legacy appliances and devices and which lack communications interfaces and processor-based controllers.

According to an aspect, the luminaire components include components suitable for use in luminaires for indoor use, such as bathroom lighting, cabinet and display lighting, commercial lighting, downlighting, emergency lighting, low level lighting, strip, flex and modular lighting, surface lighting, track lighting, uplighting, marker lights, and wall luminaries. These may further include fire rated downlighting, downlighting, LED flat panels, LED high bays, pendant lights, spotlights, track systems, bulkheads, LED strip, LED signage modules, wall lights, recessed ground lighting, suspended lighting, ceiling lights, commercial lighting, lamps, bulbs and indoor luminaire accessories.

According to an aspect, the luminaire components also include components suitable for use in luminaires for outdoor use, such as flexible outdoor lighting options including ceiling/canopy lighting, coastal lighting, floodlighting, low level lighting, pathway lighting, recessed ground lighting, spotlighting, strip, flex and modular lighting, walkover lights, wall lighting, wall washing and grazing solutions. These may further include outdoor bulkheads, outdoor wall lights, outdoor LED strip, LED signage modules, pathway lighting, wall washers, floodlighting, outdoor spotlights, submersible & coastal lighting, outdoor low level lighting, outdoor recessed ground lighting, outdoor ceiling/canopy lighting.

As would be understood by one of ordinary skill in the art, embodiments of the present disclosure include complete luminaires incorporating the luminaire components described herein, such as the types of luminaires listed above, as well as lamps (bulbs).

### BRIEF DESCRIPTION OF THE DRAWINGS

A more particular description will be rendered by reference to specific embodiments thereof that are illustrated in the appended drawings. Understanding that these drawings depict only typical embodiments thereof and are not therefore to be considered to be limiting of its scope, exemplary embodiments will be described and explained with additional specificity and detail through the use of the accompanying drawings in which:

FIG. 1 shows an assembled downlight luminaire incorporating a sensor, according to an embodiment;

FIG. 2 is a side perspective, exploded view of the downlight luminaire of FIG. 1, showing a light emitting portion and a power/control portion with a pluggable connecting cable between the two portions;

FIG. 3 is a top view of an optical lens and a sensor arrangement, according to an embodiment;

FIG. 4 is a side perspective, partially exploded view of the optical lens and sensor arrangement of FIG. 3;

FIGS. 5A and 5B are side views of the optical lens and sensor arrangement shown in FIG. 3;

FIG. 6 is a bottom view of the optical lens and sensor arrangement shown in FIG. 3, illustrating the light emitting side;

FIG. 7 is a side perspective view of an optical lens and a sensor arrangement, separated from each other, according to an aspect;

FIGS. 8 and 9 are exploded perspective views of an optical lens, a sensor arrangement, and an LED module on a first PCB, according to an aspect;

FIG. 10 is an exploded bottom perspective view of connections within a light emitting portion showing a sensor PCB, LED PCB and other components, according to an aspect;

FIG. 11 is a side perspective view of connections within a light emitting portion showing a sensor PCB, LED PCB and other components, according to an aspect; and

FIG. 12 is a side perspective view of a downlight luminaire for incorporating the connections of FIGS. 10-11.

Various features, aspects, and advantages of the embodiments will become more apparent from the following detailed description, along with the accompanying figures in which like numerals represent like components throughout the figures and text. The various described features are not necessarily drawn to scale, but are drawn to emphasize specific features relevant to some embodiments.

The headings used herein are for organizational purposes only and are not meant to limit the scope of the description or the claims. To facilitate understanding, reference numerals have been used, where possible, to designate like elements common to the figures.

### DETAILED DESCRIPTION

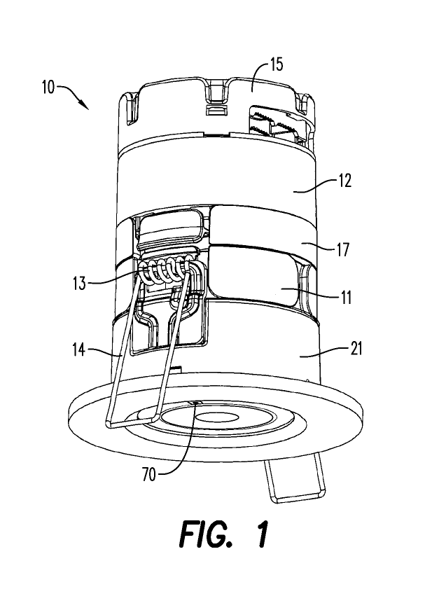

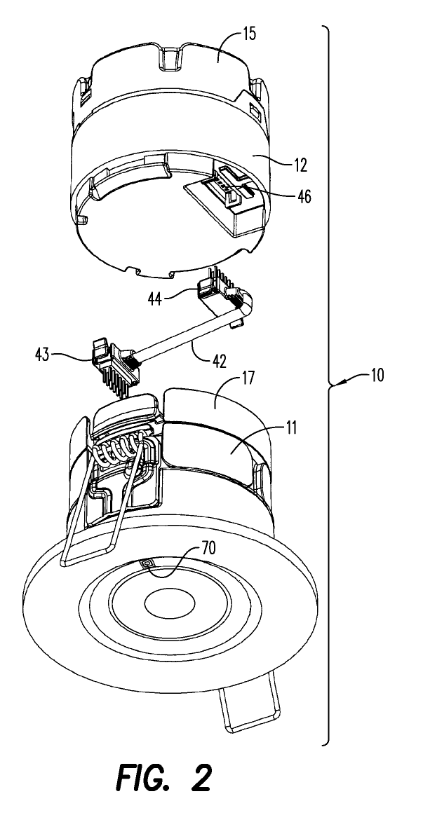

Luminaire assemblies in the form of downlights having a separate light emitting portion and a separate power/control portion are described in GB Patent Application No. GB1617719.8 (Aurora Limited), the entire text of which is hereby imported by reference in its entirety, and forms an integral part of this disclosure to the extent that it is consistent with the present disclosure. Referring to FIG. 1, a luminaire assembly in the form of a downlight assembly 10 is illustrated in its assembled configuration. The luminaire assembly includes two main parts or portions, as shown in FIG. 2, which includes a light emitting portion 11 and a power/control portion 12. According to an aspect, both portions 11, 12 are substantially tubular in cross section. A cover or end cap 15 is arranged at the top of the power/control portion 12 and serves as an insulation cover when the downlight assembly 10 is installed in its “out of the box” assembled configuration. FIG. 1 further illustrates a conventional cradle or saddle 14 and spring 13 arrangement, which serves to retain the downlight assembly 10 in an aperture in a ceiling. The components that make up the downlight assembly are shown in more detail in the exploded perspective view illustrated in FIG. 2.

According to an aspect and as illustrated in FIG. 2, the light emitting portion 11 and the power/control portion 12 are connected to each other by a pluggable connecting cable 42. The cable 42 has a plug 43, 44 at each end, and these plugs 43, 44 are adapted to engage with corresponding sockets 46 formed in the light emitting portion 11 and the power/control portion respectively 12. The plugs 43, 44 may include lugs, which are configured to engage with clips on the sockets 46 to retain each plug in its respective socket once fully inserted. This avoids a plug becoming accidentally detached from its socket in use or over time. It will be understood by one of ordinary skill in the art that the connecting cable may be an assembly of cables including one or more power cables and one or more data/control cables. Alternatively, all the necessary connecting wires may be accommodated within a single cable as shown in FIG. 2. It will also be understood by one of ordinary skill in the art, that the plug and socket arrangement could be the other way around, with the socket 46 or female parts being on the end of the connecting cable and the plugs 43, 44, or male parts, being integrated in the light emitting portion 11 and the power/control portion 12 as required.

There may be several variations of this plug and socket arrangement that might be adopted by a person skilled in the art. For example, the connecting cable could have a plug at one end and a socket at the other end, with a corresponding socket and plug in the respective portions. According to an aspect, the connecting cable may be permanently connected at one end to either the light emitting portion 11 or the power/control portion 12, with a plug or socket at the other end of the connecting cable.

The end result of these various connecting cable arrangements may be such that the power/control portion 12 and the light emitting portion 11 can be completely separated from each other in a disassembled configuration and attached together in an assembled configuration as and when required. As illustrated in FIGS. 1-2, a spacer 17 may be disposed between the power/control portion 12 and the light emitting portion 11. When the luminaire is assembled (FIG. 1), the pluggable connecting cable 42 is hidden from view or covered by the spacer 17. By constructing the luminaire assembly in two separate parts and by providing a pluggable, and therefore unpluggable, cable connection between those two parts, the power/control portion 12 can be detached completely from the light emitting portion. This provides a number of advantages, especially a major cost saving advantage in terms of inventory management that has not been possible before, and reduces the number of Stock Keeping Units (SKU) required to stock a complete range. This is because different light emitting portions 11 and different power/control portions 12 can be paired together in any desired ‘mix and match’ combination to meet the specific needs of the customer, dramatically reducing the number SKUs required to be held.

Separating the power/control portion 12 of the downlight from the light emitting portion 11 in use also serves to reduce the overall temperature of the product as the two main heat sources are separated and not contributing to one another, and therefore the total running temperature of the product is reduced. The result of this new design is a downlight, and particularly a fire rated downlight, which has an attached driver, which can also be taken off to reduce the overall height of the fitting. Fire rating may be achieved by the strategic placement of intumescent material (not shown) within the collar region 21 illustrated in FIG. 1, which may be an annular ring of intumescent material (not shown). This intumescent material may be adapted to expand inside the light emitting portion 11 in the event of a fire. This provides the required level of fire protection by preventing any fire from getting beyond the collar region 21 of the light emitting portion 11.

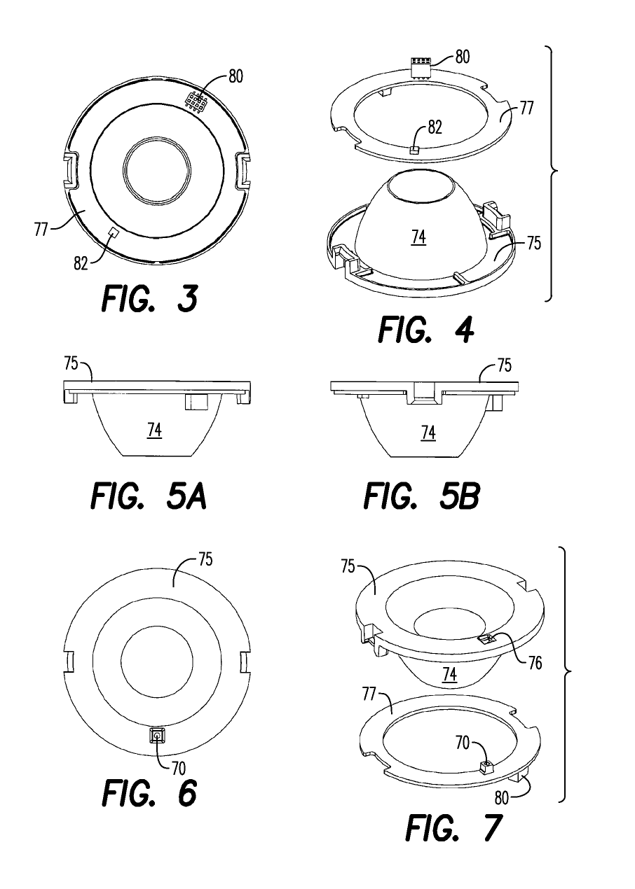

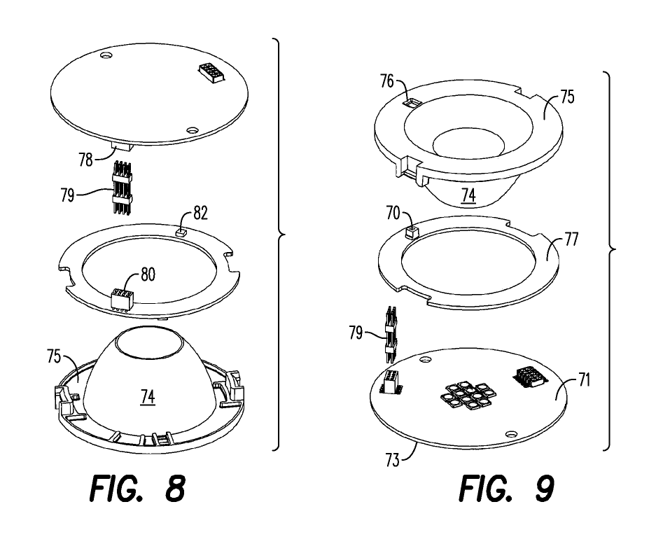

Embodiments of the present disclosure may include a forward facing sensor 70, which may be a part of a multi-part luminaire component shown more clearly in FIGS. 2 and 6. As used herein, “forward facing” is meant to mean facing in the direction in which light is emitted from the luminaire, or generally facing into the environment below the luminaire. The various parts of the luminaire component are shown more clearly in FIGS. 8 and 9. FIG. 9 shows an LED module 71 on a PCB 73. The LED module 71 may include an array 12 of individual LEDs. Also included is an optical system or lens 74 for focusing light emitted by the LED module 71, wherein the lens incorporates an outwardly extending flange 75. The lens 74 may be of a conventional design having a solid frustoconical body with a light receiving section at the rear or narrow end of the cone and a light emitting front face at the wide end of the cone. As illustrated in FIGS. 3, 4, 5A and 5B, the lens 74 may include a flange 75 around the outer circumference of the widest or light emitting front face. The flange 75 may be substantially frosted or opaque.

According to an aspect and as illustrated in FIGS. 7 and 9, the flange 75 includes an aperture 76 adapted to accommodate the sensor or sensor array 70. The sensor array 70 is mounted on its own PCB 77. The aperture 76 can take a wide variety of forms, and in this context the term ‘aperture’ has a broad meaning. The flanges around these lenses may be generally opaque or frosted. According to an aspect, the aperture 76 can therefore take the form of a substantially transparent window or gap in the frosted flange 75, a physical hole in the flange 75, or a small substantially transparent lens such as a convex lens built into the flange 75 aligned with the sensor array 70 in order to spread the sensor detection angle. In an embodiment, the ‘aperture’ 76 or transparent element in the flange 75 may consist of a convex lens in front of the sensor arrangement in order to spread the sensor detection angle. A key feature is that the sensor 70 is able to capture environmental information from an area below the lens and thus below the luminaire assembly.

In order to provide power to the sensor PCB 77 and thus to the sensor 70, and to receive data collected by sensor 70, a connection mechanism/means or connector is provided between the two PCBs. In an embodiment and as illustrated in FIG. 8, the connection means includes sockets 78 and 80 on the LED PCB and the sensor PCB respectively, and a connecting cable 79 with the required number of cores. According to an aspect, the connecting cable 79 includes 8 cores. The connecting cable 79 may be substantially rigid for ease of assembly.

As illustrated in FIGS. 3, 4 and 8, a second sensor array 82 may be provided on the reverse side of the sensor PCB 77 to the sensor array 70. This second sensor array 82 looks backwards towards the LED PCB and thus LED light source, although it is outside the lens 74. This is an advantage because sufficient light escapes from the lens, partly because of incomplete internal total reflection and partly through some light escaping form the light entering section, for the second sensor to perform its desired function of detecting the luminous flux of light emitted by the luminaire and alternatively or additionally detecting the colour temperature of light emitted by the LED light source.

Having a sensor array that faces toward the LED light source provides a particularly important functionality where the lumen output or colour temperature of the luminaire is critical. This could for example be in a retail environment where product lighting is critical. Thus the individual status of each luminaire in a chosen group of luminaires which have these backward facing sensors can be reported on a real time basis. If the performance of one or more luminaires falls below a set threshold, or fails completely, a warning can be given that a particular lamp needs to be changed, specifying exactly which lamp is faulty. This avoids the need for regular inspections of the luminaires and for the requirement to take detailed measurements of lumen output, colour temperature or CRI of each lamp in a grouping.

It may be possible, based on the individual information from a backward facing sensor in a particular luminaire, that the control IC in a particular LED light engine can “overdrive” that LED, thus increasing its light output. This will of course be at the expense of the lifetime of that LED, which will be reduced as a consequence.

This new functionality has a further important application. LED luminaires have a predicted lifetime. However, this is usually a prediction of the average time to complete failure, or to a certain percentage level of performance, but to date this has not been based on factual measurements of luminaires operating in a particular or specific working environment. Using data collected from these backward facing sensors actual data can be collected on the life of LED light engines operating in a particular working environment, and this can be used to provide much more accurate predicted lifetimes.

In summary, a feature of the dual sensor arrangement is that not only is it possible to obtain information about the environment below or around the luminaire, but it also possible to monitor characteristics of the lamp itself, for example, the intensity of the light output of the luminaire. In particular, it is now possible to measure the luminous flux of the lamp and the quality of the light output, for example the colour temperature of the output.

An advantage of this is that the intensity of the light output of the LED light engine can be controlled over its useful life by adjusting the current/voltage supplied to the LED within the lamp. In addition, the colour temperature can be maintained within a certain range. For example, if the lamp comprises two (or more) LED's of differing colour temperature, the intensity of each can be adjusted so as to give a substantially constant required colour temperature output.

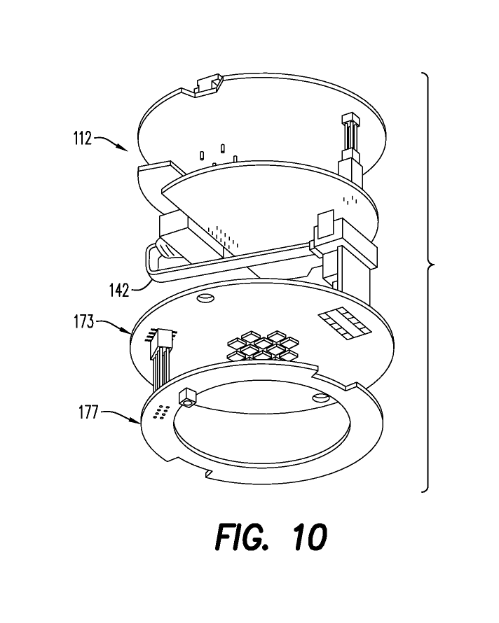

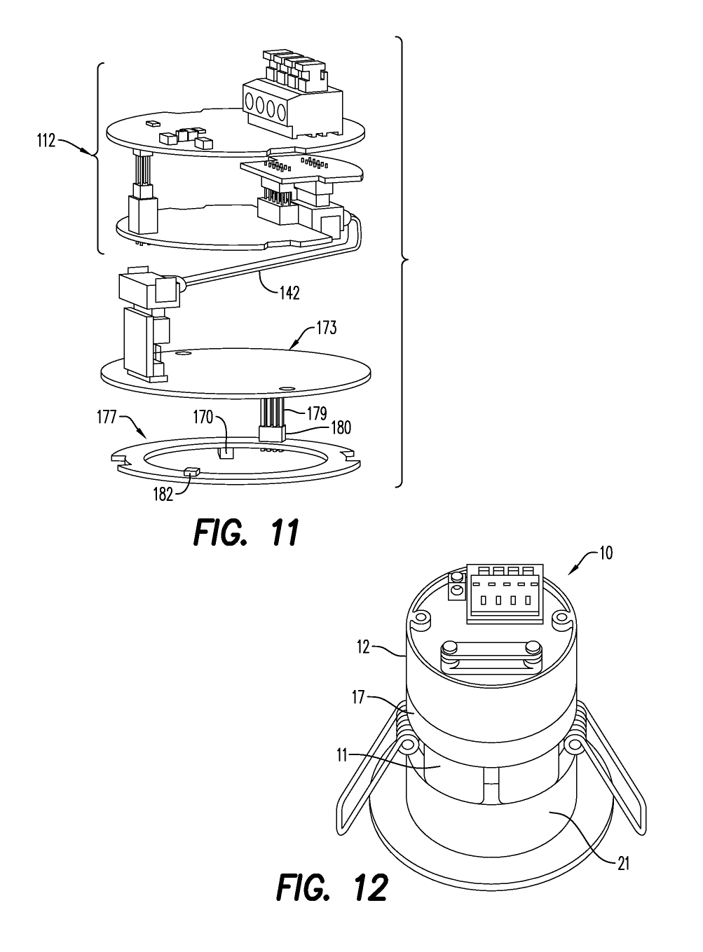

FIGS. 10 and 11 show a possible way of connecting a sensor PCB 177 to an LED PCB 173 and then into a power/control module 112 by means of connecting cable 142. A connecting cable 179 may be coupled to a socket 180 formed on the sensor PCB 177.

According to an aspect, sensor 70, 170 includes devices able to sense information about the local environment of luminaire, including proximity detectors, passive infrared (“PIR”) motion detectors, other types of motion detectors, daylight sensors, microphones or other types of acoustic detectors, charge-coupled detectors (“CCD”) or low-resolution digital cameras, ambient temperature sensors, thermopiles or thermocouples, carbon dioxide sensors, water-vapour detectors, pressure sensors, and various types of field-strength sensors that sense magnetic and electrical fields. Proximity detectors include a wide variety of different types of sensors, including capacitive, capacitive-displacement, conductive, magnetic, optical, thermal, sonar, and other types of sensors. PIR motion-detector sensors detect abrupt changes in temperatures based on infrared radiation emitted by living creatures. Other types of motion detectors include ultrasonic, microwave, and tomographic motion detectors. Audio detectors can detect sound and Acoustic detectors can detect various types of sounds or sound patterns indicative of the presence of human beings. Low-resolution cameras and CCD devices may detect changes in ambient light, including changes in ambient light due to moving objects. Thermopiles and thermocouples can be used to detect changes in temperature correlated with the presence of human beings and other living organisms. Similarly, carbon dioxide and water vapour detectors may detect gases exhaled by human beings and other living creatures, and methane detectors may detect gases present in, for example, mine workings. Pressure sensors may detect changes in pressure within an environment due to opening and closing of doors, windows, motion of large objects through the air, and other such pressure changes. Flow meters may detect the rate of flow of water, natural gas, and other gasses and liquids that flow under positive control by human beings. Field-strength sensors may detect temporal changes in field strength correlated with presence of human beings or motion of human beings through an environment.

It will be understood that the data collected by the sensor/(s) 70, 170 and sensor 82, 182 must be stored and processed. This can be done at a number of locations. These include, but are not limited to, within the luminaire by including the necessary processing function within the luminaire, remotely in a hub, or in the so-called ‘cloud’. Data can be transmitted from the luminaire to the required destination/s) using a wide variety of known techniques and protocols such as PLC, Wi-Fi, Bluetooth, BLE, ZigBee, DALI or the like.

These connections and components of FIGS. 10 and 11 may be housed or otherwise arranged within a downlight assembly 10, as illustrated in FIG. 12. The features, components and function of the downlight assembly 10 of FIG. 12 is substantially similar to the assembly 10 illustrated in FIGS. 1-2 and described hereinabove. Thus, for purposes of convenience and not limitation, those features, components, and function are not described here.

While foregoing describes various embodiments of the disclosure being applicable to downlight luminaires and the like, it would be understood by one of ordinary skill in the art, that these embodiments can be applied to other shapes and types of luminaires.

The present disclosure, in various embodiments, configurations and aspects, includes components, methods, processes, systems and/or apparatus substantially developed as depicted and described herein, including various embodiments, sub-combinations, and subsets thereof. Those of skill in the art will understand how to make and use the present disclosure after understanding the present disclosure. The present disclosure, in various embodiments, configurations and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

The terms “determine”, “calculate” and “compute,” and variations thereof, as used herein, are used interchangeably and include any type of methodology, process, mathematical operation or technique.

The foregoing discussion of the present disclosure has been presented for purposes of illustration and description. The foregoing is not intended to limit the present disclosure to the form or forms disclosed herein. In the foregoing Detailed Description for example, various features of the present disclosure are grouped together in one or more embodiments, configurations, or aspects for the purpose of streamlining the disclosure. The features of the embodiments, configurations, or aspects of the present disclosure may be combined in alternate embodiments, configurations, or aspects other than those discussed above. This method of disclosure is not to be interpreted as reflecting an intention that the present disclosure requires more features than are expressly recited in each claim. Rather, as the following claims reflect, the claimed features lie in less than all features of a single foregoing disclosed embodiment, configuration, or aspect. Thus, the following claims are hereby incorporated into this Detailed Description, with each claim standing on its own as a separate embodiment of the present disclosure.

Advances in science and technology may make equivalents and substitutions possible that are not now contemplated by reason of the imprecision of language; these variations should be covered by the appended claims. This written description uses examples to disclose the method, machine and computer-readable medium, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A luminaire component for use in a luminaire, the component comprising:
a printed circuit board (PCB) comprising a front face;
an LED module arranged on the front face of the PCB;
a sensor arrangement comprising one or more sensors; and
an optical lens for focusing light emitted by the LED module, wherein the optical lens comprises an outwardly extending flange,
wherein the sensor arrangement is located between the LED module and the outwardly extending flange of the optical lens, such that at least one of the one or more sensors is a forward facing sensor that views the environment through the outwardly extending flange.

2. The luminaire component of claim 1, further comprising:
a connection mechanism adapted to connect the sensor arrangement to the LED module.

3. The luminaire component of claim 1, wherein the flange comprises at least one of an aperture and a substantially transparent lens, and the forward facing sensor views the environment through the aperture or the substantially transparent lens.

4. The luminaire component of claim 1, wherein the sensor arrangement comprises:
at least one rearward facing sensor adapted to view light emitted by the LED module.

5. The luminaire component of claim 1, wherein the PCB is a first PCB, and the luminaire component further comprises:
a second PCB, wherein the sensor arrangement is mounted on the second PCB.

6. The luminaire component of claim 5, wherein the second PCB is substantially annular.

7. The luminaire component of claim 1, further comprising:
an array of individual LEDs arranged on the LED module.

8. The luminaire component of claim 3, wherein the substantially transparent lens is a convex lens built into the flange and aligned with the sensors to spread a sensor detection angle.

9. A luminaire component comprising:
a printed circuit board (PCB) comprising a front face;
an LED module arranged on the front face of the PCB;
a sensor arrangement comprising one or more sensors;
an optical lens configured to focus light emitted by the LED module, wherein the optical lens comprises an outwardly extending flange; and
a connection mechanism connected to the LED module and the sensors, the connection mechanism being configured to provide power to the sensor arrangement and convey data gathered by the sensor arrangement,
wherein the sensor arrangement is located between the LED module and the outwardly extending flange such that at least one of the sensors is a forward facing sensor that views the environment through the flange.

10. The luminaire component of claim 9, wherein the PCB is a first PCB, and the luminaire component further comprises:
a second PCB, wherein the sensor arrangement is mounted on the second PCB.

11. The luminaire component of claim 9, wherein the flange comprises at least one of an aperture and a substantially transparent lens, and the forward facing sensor views the environment through the aperture or the substantially transparent lens.

12. The luminaire component of claim 11, wherein the substantially transparent lens is a convex lens built into the flange and aligned with the sensors to spread a sensor detection angle.

13. The luminaire component of claim 9, further comprising:
an array of individual LEDs arranged on the LED module.

14. The luminaire component of claim 9, wherein the sensor arrangement comprises:
at least one rearward facing sensor adapted to view light emitted by the LED module.

15. The luminaire component of claim 10, wherein the connection mechanism comprises a pluggable connecting cable comprising a plug at each of its ends, wherein each plug is configured to engage with corresponding sockets formed in a luminaire.

16. A luminaire comprising:
a light emitting portion;
a power/control portion spaced apart from the light emitting portion; and
a luminaire component comprising
a printed circuit board (PCB) comprising a front face,
an LED module arranged on the front face of the PCB,
an optical lens for focusing light emitted by the LED module, wherein the optical lens comprises an outwardly extending flange, and
a sensor arrangement comprising one or more sensors, the sensor arrangement being located between the LED module and the outwardly extending flange, such that at least one of the one or more sensors is a forward facing sensor that views the environment through the outwardly extending flange, wherein the forward facing sensor faces the light emitting portion.

17. The luminaire of claim 16, wherein the luminaire is a downlight luminaire.

18. The luminaire of claim 16, further comprising:
a connection mechanism adapted to connect the sensor arrangement to the LED module.

19. The luminaire of claim 16, wherein the PCB is a first PCB, and the luminaire component further comprises:
a second PCB, wherein the sensor arrangement is mounted on the second PCB; and
a connecting cable, wherein the connecting cable connects the first PCB to the second PCB, and is configured to provide power to the sensor arrangement and convey data gathered by the sensor arrangement.

20. The luminaire component of claim 18, wherein the connection mechanism comprises:
a pluggable connecting cable comprising a plug at each of its ends, wherein each plug is configured to engage with corresponding sockets formed in a light emitting portion and a power/control portion of the luminaire.
